(19) United States
(12) Patent Application Publication
(10) Pub. No.: US 2022/0381271 A1
(43) Pub. Date: Dec. 1, 2022

(54) SUPPORT PLATFORMS

(71) Applicant: Hewlett-Packard Development Company, L.P., Spring, TX (US)

(72) Inventor: Tien Liang Chung, Taipei City (TW)

(21) Appl. No.: 17/335,369

(22) Filed: Jun. 1, 2021

(51) Int. Cl. F16B 2/18; F16M 11/04

(52) U.S. Cl. CPC F16B 2/18; F16M 11/04; F16M 2200/028; F16M 2200/024

(57) ABSTRACT

In some examples, an apparatus can include a base plate, a plurality of support platforms connected to the base plate, where each of the plurality of support platforms include an attachment plate to connect each support platform to the base plate, a spring plate, and a flange, and a cam to interface with the base plate, where the plurality of support platforms are to radially translate with respect to an axis of the base plate when the cam is rotated.

### BACKGROUND

Computing devices can allow a user to utilize computing device operations for work, education, gaming, multimedia, and/or other uses. Such computing devices may include a display device supported by a stand. In some examples, such computing devices may be incorporated into the stand as an all-in-one (AIO) computing device.

### BRIEF DESCRIPTION OF THE DRAWINGS

FIG. 1 is an exploded perspective view of an example of an apparatus including a support platform and a base plate consistent with the disclosure.

FIG. 2A is a top perspective view of an example of a support platform consistent with the disclosure.

FIG. 2B is a bottom perspective view of an example of a support platform consistent with the disclosure.

FIG. 3A is a top perspective view of an example of a cam consistent with the disclosure.

FIG. 3B is a bottom perspective view of an example of a cam consistent with the disclosure.

FIG. 4A is a perspective view of an example of an apparatus having a cam and a plurality of support platforms consistent with the disclosure.

FIG. 4B is a perspective view of an example of an apparatus having a cover and a plurality of support platforms consistent with the disclosure.

FIG. 5A is a perspective section view of an example of a computing device stand having a column and an apparatus having a cam in a disengaged orientation and a plurality of support platforms in a retracted position consistent with the disclosure.

FIG. 5B is a perspective section view of an example of a computing device stand having a column and an apparatus having a cam in an engaged orientation and a plurality of support platforms in an extended position consistent with the disclosure.

FIG. 6A is a bottom perspective view of an example of a computing device stand having a column and an apparatus having a cam in a disengaged orientation and a plurality of support platforms in a retracted position consistent with the disclosure.

FIG. 6B is a bottom perspective view of an example of a computing device stand having a column and an apparatus having a cam in an engaged orientation and a plurality of support platforms in an extended position consistent with the disclosure.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an AIO computer, among other types of computing devices.

In some computing devices, a device form factor may be a design consideration. As used herein, the term “form factor” refers to a design that defines a size, shape, and/or other physical specifications of a device. Visually appealing device form factors can lead to increased customer interest in such computing devices.

In some instances, certain form factor designs may result in a computing device design being unstable if a particular force is applied to the computing device. For example, a computing device stand that has a relatively tall and thin design may be prone to tipping over if the computing device stand receives a particular force at a particular location on the computing device. Such a force applied to a tall and thin design may result in the computing device stand tipping over, whereas a computing device that is shorter and/or thicker may not tip over if the same force was applied thereto.

While providing a form factor for a device that is, for instance, shorter and/or thicker can help with stability, the form factor may not be visually appealing. Accordingly, a manufacturer may desire a more visually appealing form factor, even though it may be less stable.

Support platforms according to the disclosure can allow for support platforms to be extended or retracted in order to provide stability for an apparatus such as a computing device stand or an AIO computing device. If a user desires stability, the support platforms can be extended to provide stability for the device to help prevent the device from tipping over, as is further described herein.

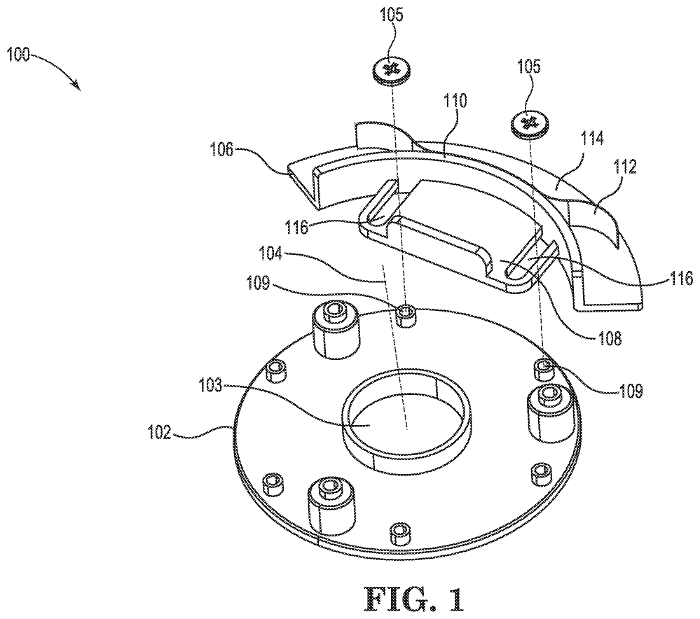

FIG. 1 is an exploded perspective view of an example of an apparatus 100 including a support platform 106 and a base plate 102 consistent with the disclosure. As illustrated in FIG. 1, the support platform 106 can be attached to the base plate 102 via fasteners 105.

As illustrated in FIG. 1, the apparatus 100 can include a base plate 102. As used herein, the term “base plate” refers to an object to which other objects are attached for support. For example, the base plate 102 can have support platforms 106 attached thereto to provide stability for a device, as is further described herein.

As illustrated in FIG. 1, the base plate 102 can be substantially circularly shaped. However, examples of the disclosure are not so limited. For example, the base plate 102 can be substantially rectangularly shaped, substantially triangularly shaped, and/or any other shape in order to be incorporated into a design form factor of a device such as a computing device stand, an AIO computing device, etc. In such examples, the support platforms 106 attached to the base plate 102 can vary in shape based on the base plate 102 being substantially rectangularly shaped, substantially triangularly shaped, etc.

The base plate 102 can include an aperture 103. As used herein, the term “aperture” refers to an opening through a material. The aperture 103 can be substantially circular similar to the shape of the base plate 102. For example, the substantially circular base plate 102 can include a substantially circular aperture 103. The base plate 102 can include a central axis 104 through a center of the base plate 102.

The apparatus 100 can include a support platform 106. As used herein, the term “support platform” refers to a rigid object that serves to provide stability to another object. The support platform 106 can provide support and stability to a device, as is further described herein.

The support platform 106 can include an attachment plate 108. As used herein, the term “plate” refers to a portion of material. The attachment plate 108 can be utilized to connect the support platform 106 to the base plate 102. For instance, as illustrated in FIG. 1, the support platform 106 can include attachment channels 116. As used herein, the term “channel” refers to an opening through a material. The attachment channels 116 can be openings through the attachment plate 108.

The support platform 106 can be connected to the base plate 102 via fasteners 105 positioned in the attachment channels 116 of the attachment plate 108. As used herein, the term “fastener” refers to a device to a device that mechanically joins objects together. The fasteners 105 can be threaded fasteners that can include an external male thread that can be received by a matching female thread included in tapped housings 109 included on the base plate 102. For example, as illustrated in FIG. 1, the fasteners 105 can be bolts that can be inserted through the attachment channels 116 and received by the tapped housings 109.

Although the fasteners 105 are described above as being bolts, examples of the disclosure are not so limited. For example, the fasteners 105 can be screws, rivets, and/or any other type of fastener.

The support platform 106 can include a spring plate 110. The spring plate 110 can be a portion of material utilized to connect a cantilever spring 112 to the support platform 106. Additionally, the support platform 106 can include a flange 114. As used herein, the term “flange” refers to an external rim of material. The flange 114 can provide support for a device when the support platform 106 is in an extended position, as is further described herein.

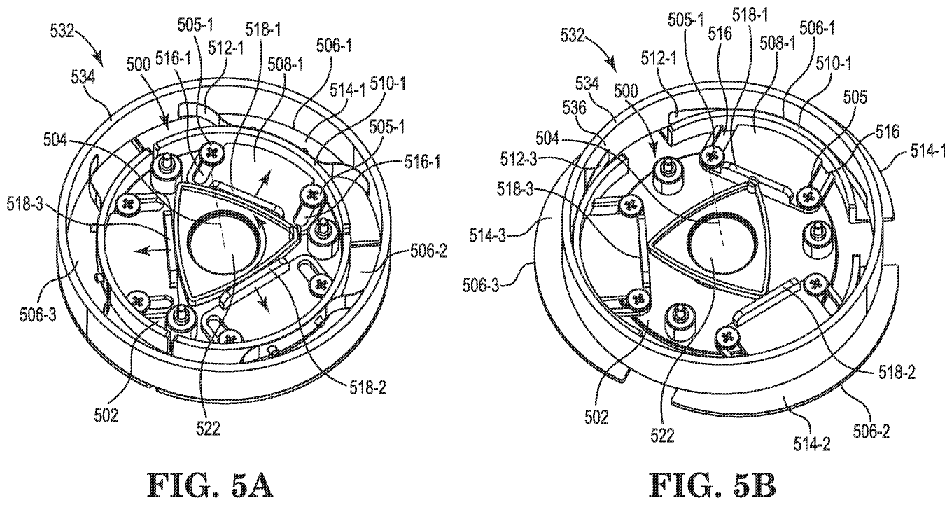

Although a single support platform 106 is illustrated in FIG. 1, examples of the disclosure are not so limited. For example, the base plate 102 can have a plurality of support platforms 106 connected thereto. Each of the plurality of support platforms 106 can include an attachment plate having attachment channels, a spring plate having a cantilever spring 112 connected thereto, and a flange 114. Each of the plurality of support platforms 106 can be radially translatable relative to the fasteners 105 and the base plate 102. For example, the support platform 106 can radially translate away from the central axis 104 or towards the central axis 104, as is further described in connection with FIGS. 5A and 5B.

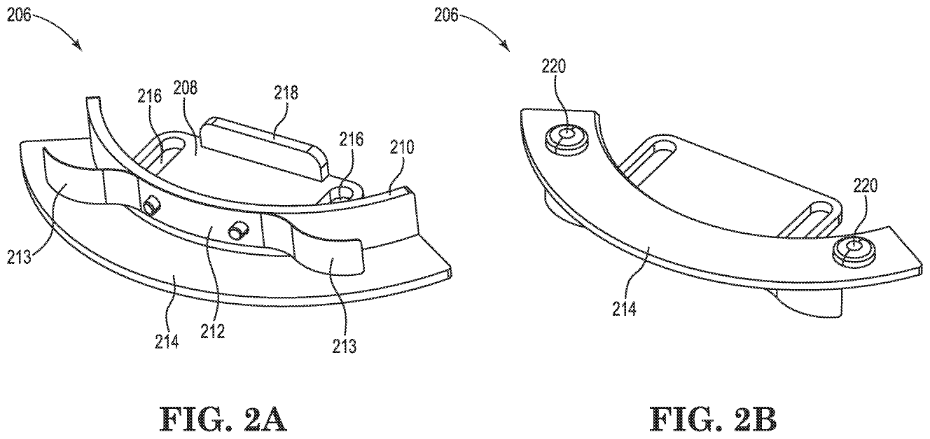

FIG. 2A is a top perspective view of an example of a support platform 206 consistent with the disclosure. As illustrated in FIG. 2A, the support platform 206 can include an attachment plate 208, a spring plate 210, and a flange 214.

As previously described in connection with FIG. 1, the attachment plate 208 can include attachment channels 216. Fasteners can be positioned in the attachment channels 216 to connect the support platform 206 to a base plate.

The support platform 206 can further include a push plate 218. The push plate 218 can be a portion of material on which a cam exerts a force. The cam can exert a force on the push plate 218 to cause the support platform 206 to radially translate away from an axis of a base plate, as is further described in connection with FIGS. 5A and 5B.

The spring plate 210 can include a cantilever spring 212. As used herein, the term “cantilever spring” refers to an arc-shaped elastic device that stores mechanical energy. The cantilever spring 212 can be connected to the spring plate 210 and include two “free-hanging” ends 213. The free-hanging ends 213 of the cantilever spring 212 can receive a load to cause the cantilever spring 212 to store mechanical energy, whereas the middle portion of the cantilever spring 212 is fixed to the spring plate 210.

As illustrated in FIG. 2A, the cantilever spring 212 can be in a decompressed state. As used herein, the term “decompressed state” refers to a state in which a free-hanging end of a cantilever spring is not receiving a load. The free-hanging ends 213 of the cantilever spring 212 can receive a load to be in a compressed state when the support platform 206 radially translates away from an axis of a base plate, as is further described in connection with FIGS. 5A and 5B.

FIG. 2B is a bottom perspective view of an example of a support platform 206 consistent with the disclosure. A flange 214 of the support platform 206 can include footings 220. As used herein, the term “footing” refers to a device to provide grip. For example, the footings 220 can provide grip for a device.

The footings 220 can be connected to a bottom portion of the flange 214. The footings 220 can be utilized to engage a surface. For example, when the device (e.g., a computing device stand, an AIO computing device, etc.) is resting on a surface (e.g., such as a desktop, tabletop, etc.), the footings 220 can engage the surface in order to support the device and/or resist translation of the device on the surface when the device has a force applied thereto. The footings 220 can be, for instance, a rubber material having a sufficient coefficient of friction to resist translation of the device on the surface, although examples of the disclosure are not limited to the footings 220 being a rubber material. For instance, the footings 220 can be any other type of material having a sufficient coefficient of friction to resist translation of the device on the surface.

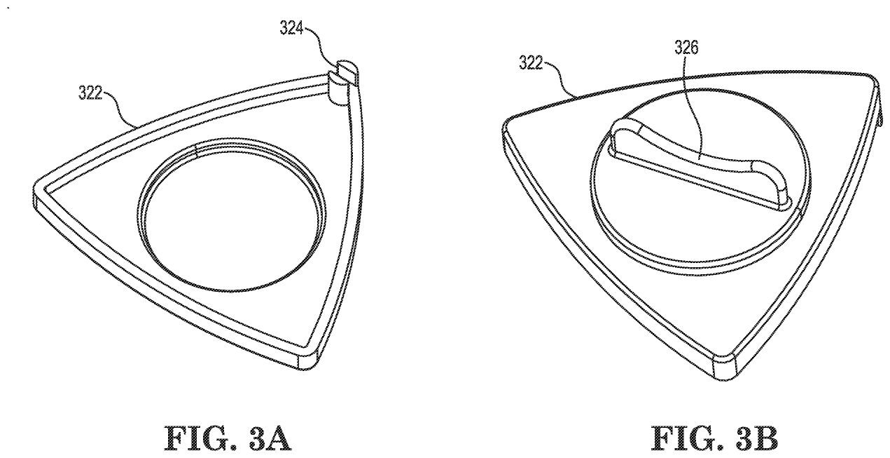

FIG. 3A is a top perspective view of an example of a cam 322 consistent with the disclosure. The cam 322 can interface with a base plate. As used herein, the term “cam” refers to a mechanical device to transform rotary motion into linear motion. For example, when the cam 322 is rotated, the cam 322 can cause support platforms to radially translate, as is further described in connection with FIGS. 5A and 5B.

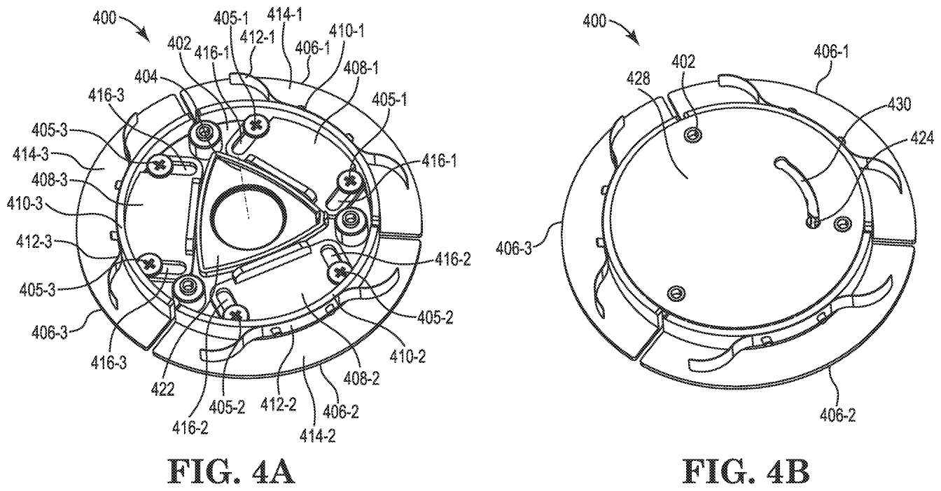

The cam 322 can include a post 324. As used herein, the term “post” refers to an upright portion of material. The post 324 can interface with a guide slot of a cover to guide rotation of the cam 322, as is further described in connection with FIG. 4B.

FIG. 3B is a bottom perspective view of an example of a cam 322 consistent with the disclosure. The cam 322 can include a handle 326. As used herein, the term “handle” refers to a portion of an object to be grasped by a hand. For instance, the handle 326 can be grasped by a hand of a user. The cam 322 can be rotatable via the handle 326. For example, a user can utilize the handle 326 to rotate the cam 322 to cause support platforms to radially translate, as is further described in connection with FIGS. 5A and 5B.

FIG. 4A is a perspective view of an example of an apparatus 400 having a cam 422 and a plurality of support platforms 406 consistent with the disclosure. The apparatus 400 can include a base plate 402 having the plurality of support platforms 406 attached thereto.

As illustrated in FIG. 4A, the apparatus 400 can be partially assembled. The base plate 402 can include a plurality of support platforms 406-1, 406-2, 406-3 (referred to collectively herein as support platforms 406) connected thereto. Each of the plurality of support platforms 406 can include an attachment plate, a spring plate, and a flange. For example, the support platform 406-1 can include an attachment plate 408-1 having attachment channels 416-1, a spring plate 410-1 having a cantilever spring 412-1 connected thereto, and a flange 414-1. Additionally, the support platform 406-2 can include an attachment plate 408-2 having attachment channels 416-2, a spring plate 410-2 having a cantilever spring 412-2 connected thereto, and a flange 414-2. Further, the support platform 406-3 can include an attachment plate 408-3 having attachment channels 416-3, a spring plate 410-3 having a cantilever spring 412-3 connected thereto, and a flange 414-3.

Each of the support platforms 406 can be connected to the base plate 402 by fasteners 405. For example, fasteners 405-1 can be located in attachment channels 416-1 to connect the support platform 406-1 to the base plate 402, fasteners 405-2 can be located in attachment channels 416-2 to connect the support platform 406-2 to the base plate 402, and fasteners 405-3 can be located in attachment channels 416-3 to connect the support platform 406-3 to the base plate 402.

Each of the support platforms 406 can be positioned circumferentially around the base plate 402. For example, the support platforms 406 can be positioned in a substantially circular fashion around the circumference of the substantially circular base plate 402.

The cam 422 can be interfaced with the base plate 402. For example, although not illustrated in FIG. 4A, the cam 422 can interface with an aperture of the base plate 402. The support platforms 406 can radially translate with respect to the axis 404 when the cam 422 is rotated, as is further described in connection with FIGS. 5A and 5B.

FIG. 4B is a perspective view of an example of an apparatus 400 having a cover 428 and a plurality of support platforms 406 consistent with the disclosure. As illustrated in FIG. 4B, the apparatus 400 can be partially assembled and further include the cover 428 as compared with the apparatus 400 previously illustrated in FIG. 4A.

Similar to the apparatus 400 from FIG. 4A, the apparatus 400 can include a plurality of support platforms 406-1, 406-2, 406-3 connected to a base plate 402. A cam can be interfaced with the base plate 402.

The apparatus 400 can include the cover 428. As used herein, the term “cover” refers to an object that substantially covers other objects. The cover 428 can, for instance, substantially cover the cam and portions of the support platforms 406.

The cover 428 can include a guide slot 430. As used herein, the term “guide slot” refers to an opening through an object to guide motion of another object. For example, the guide slot 430 can guide rotation of the cam, as is further described herein.

The cam can include a post 424. The post 424 can interface with the guide slot 430. When interfaced with the guide slot 430, the post 424 can be partially located in the guide slot 430 to guide rotation of the cam. For example, the guide slot 430 can be oriented such that the guide slot 430 allows the post 424 (e.g., and the cam) to travel a predefined rotational amount. For example, when the cam is rotated from a disengaged orientation to an engaged orientation or from the engaged orientation to the disengaged orientation, the guide slot 430 allows the cam to rotate a predefined amount (e.g., 30°), as the rotational travel amount of the cam is fixed based on the post 424 and the dimensions of the guide slot 430.

FIG. 5A is a perspective section view of an example of a computing device stand 532 having a column 534 and an apparatus 500 having a cam 522 in a disengaged orientation and a plurality of support platforms 506 in a retracted position consistent with the disclosure. The apparatus 500 can be substantially positioned within the column 534.

The computing device stand 532 can include a column 534. As used herein, the term “column” refers to an upright support. The column 534 can be utilized to support components of a computing device. For instance, in some examples the column 534 can support a display of a computing device. In some examples, the computing device can be an AIO computing device and the column 534 can include components of the computing device, such as a motherboard, a power supply, storage drives (e.g., floppy drives or optical drives such as CD-ROM, CD-RW, DVD-ROM, etc.), memory, a hard disk, a video card, a sound card, among other components.

The apparatus 500 can be partially located in the column 534 and can include a base plate 502 including an aperture (e.g., not illustrated in FIG. 5A) and a central axis 504. The base plate 502 can include a plurality of support platforms 506-1, 506-2, 506-3 connected thereto. For example, the base plate 502 can include three support platforms 506-1, 506-2, 506-3 connected thereto. Similar to the apparatus described in connection with FIG. 4A, each of the plurality of support platforms 506-1, 506-2, 506-3 can include an attachment plate having an attachment channel, a spring plate including a cantilever spring, a push plate, and a flange. For example, the support platform 506-1 can include an attachment plate 508-1 having attachment channels 516-1, where fasteners 505-1 connect the support platform 506-1 to the base plate 502. The spring plate 510-1 can include a cantilever spring 512-1. Support platforms 506-2 and 506-3 include similar components.

The apparatus 500 can further include the cam 522 interfaced with the aperture of the base plate 502. The cam 522 can be substantially triangularly shaped to cause the support platforms 506-1, 506-2, 506-3 to radially translate relative to the central axis 504 in response to the cam 522 being rotated.

As illustrated in FIG. 5A, the cam 522 can be in a disengaged orientation. As used herein, the term “disengaged orientation” refers to an orientation of a cam in which the cam causes support platforms to be in a retracted position. For example, the orientation of the cam 522 as illustrated in FIG. 5A can allow the support platforms 506-1, 506-2, 506-3 to be in a retracted position. As used herein, the term “retracted position” refers to an orientation of a support plate in which a flange of the support plate is substantially located within a column. For example, when in the retracted position, the flanges 514-1, 514-2, 514-3 of the support platforms 506-1, 506-2, 506-3, respectively, can be substantially located within the column 534. Accordingly, in the retracted position, the support platforms 506-1, 506-2, 506-3 provide less stability for the computing device stand 532 as compared to the support platforms 506-1, 506-2, 506-3 being in the extended position, as is further described in connection with FIG. 5B.

When the cam 522 is in the disengaged orientation and the support platforms 506-1, 506-2, 506-3 are in the retracted position, the cantilever springs 512-1, 512-2, 512-3 can be in the decompressed state. For example, the free-hanging ends of the cantilever springs 512-1, 512-2, 512-3 can be decompressed and as such are not experiencing a load.

In an example in which additional stability is desired, a user can rotate the cam 522. Rotating the cam 522 from the disengaged orientation to an engaged orientation can cause the support platforms 506-1, 506-2, 506-3 to radially translate from the retracted position to an extended position. For example, as the cam 522 is rotated (e.g., counterclockwise as oriented in FIG. 5A), the vertices of the cam 522 (e.g., the three points at which the edges of the cam 522 intersect) can push on the push plates 518-1, 518-2, 518-3 of the support platforms 506-1, 506-2, 506-3, respectively. As a result, the support platforms 506-1, 506-2, 506-3 can radially translate away from the central axis 504. For example, the support platform 506-1 can radially translate relative to the fasteners 505-1 and the base plate 502 away from the central axis 504. The support platforms 506-2 and 506-3 can similarly radially translate away from the central axis 504 as a result of the cam 522 being rotated from the disengaged orientation to the engaged orientation.

Although not illustrated in FIG. 5A, the apparatus 500 can include a cover having a guide slot (e.g., cover 428 having a guide slot 430, as previously described in connection with FIG. 4B). The guide slot can guide rotation of the cam 522 from the disengaged orientation to the engaged orientation.

FIG. 5B is a perspective section view of an example of a computing device stand 532 having a column 534 and an apparatus 500 having a cam 522 in an engaged orientation and a plurality of support platforms 506 in an extended position consistent with the disclosure.

As previously described in connection with FIG. 5A, rotation of the cam 522 from the disengaged orientation to the engaged orientation (e.g., as illustrated in FIG. 5B) can cause the support platforms 506-1, 506-2, 506-3 to radially translate from the retracted position to an extended position. As used herein, the term “engaged orientation” refers to an orientation of a cam in which the cam causes support platforms to be in an extended position. For example, the orientation of the cam 522 as illustrated in FIG. 5B can allow the support platforms 506-1, 506-2, 506-3 to be in the extended position. As used herein, the term “extended position” refers to an orientation of a support plate in which a flange of the support plate is substantially located outside of a column. When in the extended position, the flanges 514-1, 514-2, 514-3 of the support platforms 506-1, 506-2, 506-3, respectively, can be substantially located outside of the column 534. Accordingly, in the extended position, the support platforms 506-1, 506-2, 506-3 provide more stability for the computing device stand 532 as compared to the support platforms 506-1, 506-2, 506-3 being in the retracted position, as previously described in connection with FIG. 5A.

When the cam 522 is rotated from the disengaged orientation to the engaged orientation, the support platforms 506-1, 506-2, 506-3 are to radially translate away from the central axis 504 from the retracted position to the extended position in response to the cam 522 pushing on the push plates 518-1, 518-2, 518-3 of the support platforms 506-1, 506-2, 506-3, respectively. The cam 522 pushing on the push plates 518-1, 518-2, 518-3 can cause the cantilever springs 512-1, 512-2 of the support platforms 506-1, 506-2, respectively, and a cantilever spring of support plate 506-3 (e.g., not illustrated in FIG. 5B) to be in a compressed state. As used herein, the term “compressed state” refers to a state in which a free-hanging end of a cantilever spring is receiving a load. For example, when the support platforms 506-1, 506-2, 506-3 radially translate away from the central axis 504 to an extended position, the support platforms 506-1, 506-2, 506-3 translate radially towards the column 534. As the support platforms 506-1, 506-2, 506-3 get closer to the column 534, an inner wall 536 of the column 534 can press on and compress the free-hanging ends of the cantilever springs 512-1, 512-2, and the cantilever spring connected to the support plate 506-3. Accordingly, as illustrated in FIG. 5B, each of the cantilever springs 512-1, 512-2, and the cantilever spring connected to the support plate 506-3 can be compressed against the inner wall 536 of the column 534 in a compressed state.

In an example in which a user wishes to have the support platforms 506-1, 506-2, 506-3 in a retracted state, a user can rotate the cam 522 from the engaged orientation (e.g., as illustrated in FIG. 5B) to a disengaged orientation (e.g., as illustrated in FIG. 5A). In response to the cam 522 being rotated from the engaged orientation to the disengaged orientation, each of the cantilever springs 512-1, 512-2, and the cantilever spring connected to the support platform 506-2 can decompress to a decompressed state, causing the support platforms 506-1, 506-2, 506-3 to radially translate towards the central axis 504 from the extended position to the retracted position.

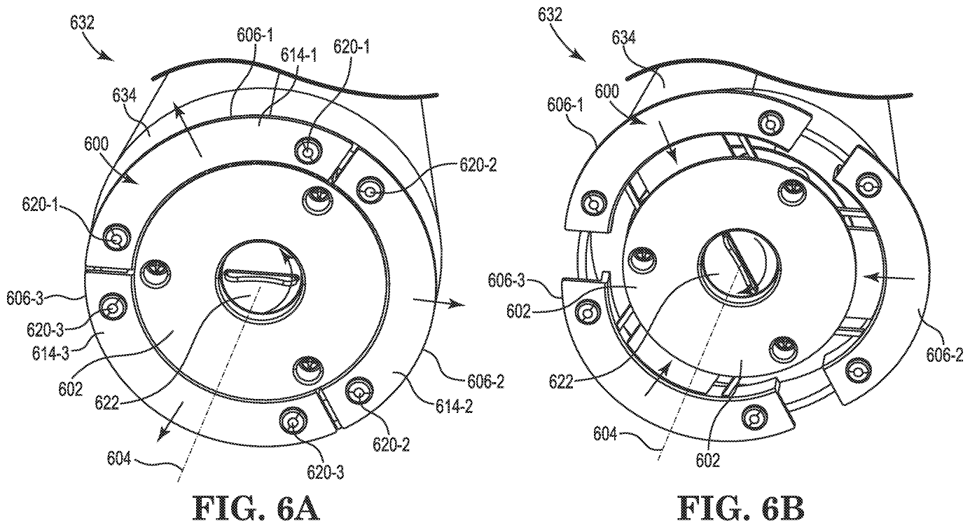

FIG. 6A is a bottom perspective view of an example of a computing device stand 632 having a column 634 and an apparatus 600 having a cam 622 in a disengaged orientation and a plurality of support platforms 606-1, 606-2, 606-3 in a retracted position consistent with the disclosure. The plurality of support platforms 606-1, 606-2, 606-3 can be connected to a base plate 602.

FIG. 6A illustrates the plurality of support platforms 606-1, 606-2, 606-3 in a retracted position. Each of the plurality of support platforms 606-1, 606-2, 606-3 can include a flange 614-1, 614-2, 614-3, respectively. Each of the flanges 614-1, 614-2, 614-3 can include footings 620-1, 620-2, 620-3, respectively to engage a surface to support the computing device stand 632 and/or resist translation of the computing device stand 632 on the surface.

If a user desires additional support for the computing device stand 632, the user can rotate the cam 622 counterclockwise from a disengaged orientation (e.g., as illustrated in FIG. 6A) to an engaged orientation (e.g., as illustrated in FIG. 6B). As the cam 622 is rotated from the disengaged orientation to the engaged orientation, the plurality of support platforms 606-1, 606-2, 606-3 can radially translate away from the central axis 604 relative to the base plate 602, as is further illustrated in FIG. 6B.

FIG. 6B is a bottom perspective view of an example of a computing device stand 632 having a column 634 and an apparatus 600 having a cam 622 in an engaged orientation and a plurality of support platforms 606-1, 606-2, 606-3 in an extended position consistent with the disclosure.

FIG. 6B illustrates the plurality of support platforms 606-1, 606-2, 606-3 in an extended position. In the extended position, the plurality of support platforms 606-1, 606-2, 606-3 can provide additional support for the computing device stand 632 relative to the plurality of support platforms 606-1, 606-2, 606-3 being in a retracted position.

If, for instance, a user desires the plurality of support platforms 606-1, 606-2, 606-3 to be in the retracted position (e.g., for aesthetic reasons, transportation of the computing device stand 632, storage of the computing device stand 632, etc.), the user can rotate the cam 622 clockwise from an engaged orientation (e.g., as illustrated in FIG. 6B) to a disengaged orientation (e.g., as illustrated in FIG. 6A). As the cam 622 is rotated from the disengaged orientation to the engaged orientation, the plurality of support platforms 606-1, 606-2, 606-3 can radially translate towards from the central axis 604 relative to the base plate 602.

Support platforms according to the disclosure can allow for stability for an apparatus while preserving an aesthetically pleasing look. The apparatus can utilize support platforms that can be extended or retracted in order to provide stability if a user so desires.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 106 may refer to element 106 in FIG. 1 and an analogous element may be identified by reference numeral 206 in FIG. 2A. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a base plate;
a plurality of support platforms connected to the base plate, wherein each of the plurality of support platforms include:
an attachment plate to connect each support platform to the base plate;
a spring plate; and
a flange; and
a cam to interface with the base plate;
wherein the plurality of support platforms are to radially translate with respect to an axis of the base plate when the cam is rotated.

2. The apparatus of claim 1, wherein in response to the cam being rotated from a disengaged orientation to an engaged orientation, the plurality of support platforms are to radially translate from a retracted position to an extended position.

3. The apparatus of claim 1, wherein in response to the cam being rotated from an engaged orientation to a disengaged orientation, the plurality of support platforms are to radially translate from an extended position to a retracted position.

4. The apparatus of claim 1, wherein each of the attachment plates of the plurality of support platforms include an attachment channel.

5. The apparatus of claim 4, wherein each of the plurality of support platforms are connected to the base plate via a fastener positioned in the attachment channel of each attachment plate.

6. The apparatus of claim 5, wherein each of the plurality of support platforms are radially translatable relative to the fastener and the base plate of each respective support platform.

7. An apparatus, comprising:
a base plate including an aperture;
a plurality of support platforms connected to the base plate and positioned circumferentially around the base plate, wherein each of the plurality of support platforms includes:
an attachment plate having an attachment channel, wherein a fastener is to connect each support platform to the base plate via the respective attachment channel;
a spring plate; and
a flange; and
a cam to interface with the aperture of the base plate;
wherein the plurality of support platforms are to radially translate with respect to an axis of the base plate when the cam is rotated.

8. The apparatus of claim 7, where each spring plate of the plurality of support platforms includes a cantilever spring.

9. The apparatus of claim 8, wherein the cantilever spring of each of the plurality of support platforms is:
in a decompressed state when the plurality of support platforms are in a retracted position; and
in a compressed state when the plurality of support platforms are in an extended position.

10. The apparatus of claim 7, wherein:
the cam includes a handle; and
the cam is rotatable via the handle.

11. The apparatus of claim 7, wherein:
the apparatus further includes a cover connected to the base plate, the cover including a guide slot; and
the cam includes a post to interface with the guide slot such that the guide slot is to guide rotation of the cam.

12. A computing device stand, comprising:
a column; and
an apparatus partially located in the column, wherein the apparatus comprises:
a base plate including an aperture and a central axis;
a plurality of support platforms connected to the base plate and positioned circumferentially around the base plate, wherein each of the plurality of support platforms includes:
an attachment plate having an attachment channel, wherein a fastener is to connect each support platform to the base plate via the respective attachment channel;
a spring plate including a cantilever spring;
a push plate; and
a flange; and
a cam to interface with the aperture of the base plate;
wherein:
in response to the cam being rotated from a disengaged orientation to an engaged orientation, the plurality of support platforms are to radially translate away from the central axis from a retracted position to an extended position in response to the cam pushing on the push plates of each of the plurality of support platforms further causing each of the cantilever springs to be in a compressed state; and
in response to the cam being rotated from the engaged orientation to the disengaged orientation, each of the cantilever springs are to cause the plurality of support platforms to radially translate towards the central axis from the extended position to the retracted position.

13. The computing device stand of claim 12, wherein:
when the plurality of support platforms are in the extended position, each of the cantilever springs are compressed against an inner wall of the column in a compressed state; and
in response to the cam being rotated from the engaged orientation to the disengaged orientation, each of the cantilever springs are to decompress to a decompressed state to cause the plurality of support platforms to radially translate towards the central axis.

14. The computing device stand of claim 12, wherein:
the plurality of support platforms include three support platforms; and
the cam is substantially triangularly shaped to cause the three support platforms to radially translate relative to the central axis in response to the cam being rotated.

15. The computing device stand of claim 12, wherein each flange of the plurality of support platforms includes a footing to engage a surface to at least one of:
support the computing device stand; and
resist translation of the computing device stand on the surface.
